(19) United States
(12) Patent Application Publication
(10) Pub. No.: US 2014/0351349 A1
(43) Pub. Date: Nov. 27, 2014

(54) NETWORK SYSTEM, MANAGEMENT SERVER, AND UPDATE NOTIFICATION METHOD

(71) Applicant: KABUSHIKI KAISHA TOSHIBA, Tokyo (JP)

(72) Inventor: Ikumi Irioka, Ome-shi (JP)

(73) Assignee: KABUSHIKI KAISHA TOSHIBA, Tokyo (JP)

(21) Appl. No.: 14/183,192

(22) Filed: Feb. 18, 2014

(30) Foreign Application Priority Data
May 27, 2013 (JP) 2013-110759

(51) Int. Cl. H04L 12/911; H04L 12/58

(52) U.S. Cl. CPC H04L 47/70; H04L 51/04
USPC 709/206; 709/225

(57) ABSTRACT

According to one embodiment, a network system includes a first computer, a second computer and a third computer. The first computer is configured to set access rights to a storage medium in units of folders or files. The third computer is configured to manage a relationship between the first computer and the second computer. The third computer includes a first notification module. The first notification module is configured to notify the second computer of an update of the first folder or the first file, when the folder or the file in the storage medium is updated.

### CROSS-REFERENCE TO RELATED APPLICATIONS

This application is based upon and claims the benefit of priority from Japanese Patent Application No. 2013-110759, filed May 27, 2013; the entire contents of which are incorporated herein by reference.

### FIELD

Embodiments described herein relate generally to technology of notifying update of a folder or a file, more specifically, update of a folder or a file on a storage medium managed by a computer that is accessible by at least one other computer via a network in a network system.

### BACKGROUND

With the growth of such network infrastructure as the Internet, information is being widely shared not only among companies but also among individuals. Various proposals have been made for managing such information sharing.

The way of sharing information (files) between user A and user B is not limited to one. For example, one option is to store a file on a storage medium of a computer referred to as a file server, and another option is to allow a storage medium of a computer used by user A, for example, to be accessible by a computer used by user B, and to store a file on the storage medium in the computer of user A.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing the structure of a network system according to an embodiment.

FIG. 2 is an exemplary illustration showing the structure of a management server applied to the network system of the embodiment.

FIG. 3 is an exemplary illustration for explaining the overall operational flow when a folder is directly updated on a personal cloud server of the network system of the embodiment.

FIG. 4 is an exemplary first view (pattern 1) for explaining the overall operational flow when a folder on the personal cloud server is updated by a pairing client of the network system of the embodiment.

FIG. 5 is an exemplary second view (pattern 2) for explaining the overall operational flow when a folder on the personal cloud server is updated by the pairing client of the network system of the embodiment.

FIG. 6 is an exemplary flowchart showing the flow of folder update notification processing executed by the management server applied to the network system of the embodiment.

### DETAILED DESCRIPTION

Various embodiments will be described hereinafter with reference to the accompanying drawings.

In general, according to one embodiment, a network system includes a first computer, a second computer and a third computer. The first computer is configured to set access rights to a storage medium managed by the first computer in units of folders or files. The second computer has either (1) an access right of being permitted to update a first folder or a first file on the storage medium via a network, or (2) an access right of being prohibited from updating the first folder or the first file. The third computer is configured to manage a relationship between the first computer and the second computer, and to serve as an intermediary between the first computer and the second computer via the network. The third computer includes a first notification module. The first notification module is configured to notify the second computer of an update of the first folder or the first file, when the first folder or the first file is updated.

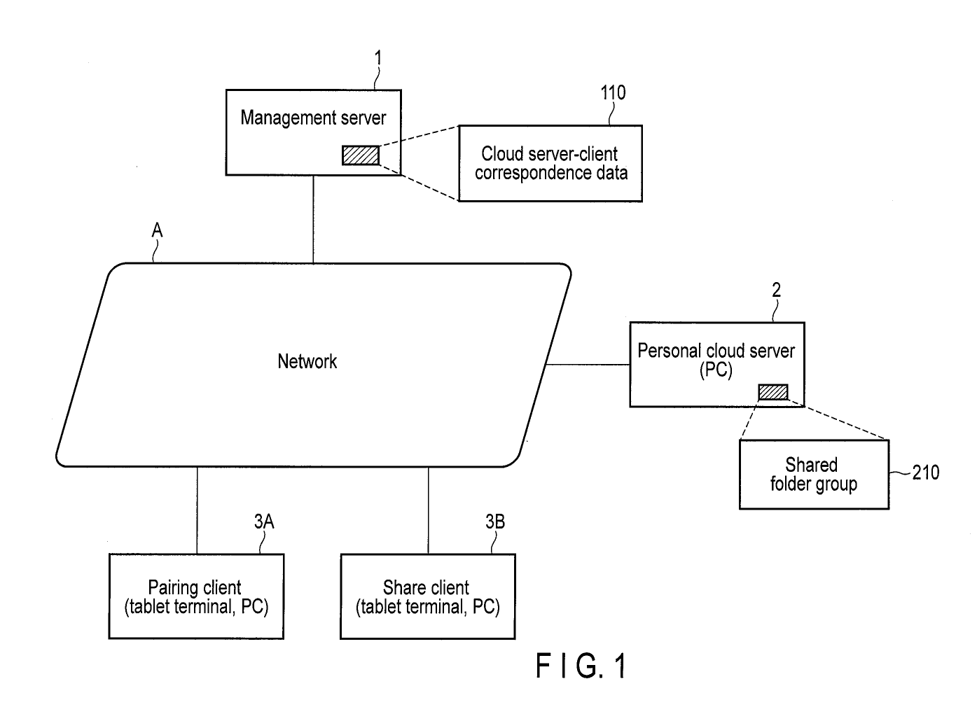

FIG. 1 is an exemplary illustration showing the structure of a network system of the present embodiment.

As shown in FIG. 1, the present network system includes a management server 1, a personal cloud server 2, a pairing client 3A, and a share client 3B. These constituent elements are connected to each other via network A, such as the Internet.

The network system is a system in which a folder created on a storage medium managed by a certain computer (first computer) can be accessed by at least one other computer (second computer) via a network. A computer which manages the storage medium on which a folder is created is referred to as the personal cloud server 2, and a computer which accesses the folder on the personal cloud server 2 through the network is referred to as the pairing client 3A or the share client 3B. The pairing client 3A is a computer which has the access right of being allowed to update a folder on the personal cloud server 2. That is, the pairing client 3A is allowed to add (upload), update, or delete a file in a folder, in addition to browsing (downloading) a file in a folder on the personal cloud server 2. Meanwhile, the share client 3B is a computer which can download a file in a folder on the personal cloud server 2, but cannot, for example, upload, update or delete a file in a folder. In other words, the share client 3B is a computer which has the access right of not being permitted to update a folder on the personal cloud server 2.

The personal cloud server 2 includes the function of assigning the access rights to other computers (pairing client 3A or share client 3B) in units of folders created on the storage medium managed by the personal cloud server 2. Of the folder groups created on the storage medium managed by the personal cloud server 2, shared folder group 210 shown in FIG. 1 represents a folder group for which the access rights are assigned to the other computers. The personal cloud server 2 is a personal computer (PC), for example, and the pairing client 3A and the share client 3B are a tablet terminal or a PC, etc.

The management server 1 manages the relationship between the personal cloud server 2, and the pairing client 3A and the share client 3B. Further, the management server 1 is a computer (third computer) serving as an intermediary of connection between the personal cloud server 2, and the pairing client 3A and the share client 3B. The management server 1 manages cloud server-client correspondence data 110 in which each folder on the personal cloud server 2 is associated with the pairing client 3A or the share client 3B having the right to access each of those folders. The management server 1 acquires the setting status of access rights in units of folders from the cloud server 2, and keeps the cloud server-client correspondence data 110 up-to-date. The setting status of access right is to be informed to the management server 1 from the personal cloud server 2, for example, as appropriate (such as when the access right has been set).

The management server 1 accepts an access request from the pairing client 3A or the share client 3B. Then, based on the cloud server-client correspondence data 110, the management server 1 confirms the corresponding personal cloud server 2 and executes the procedure for connecting the pairing client 3A or the share client 3B to the personal cloud server 2 via network A. By the service provided by the management server 1, it is possible to easily construct a network system for sharing folders among a plurality of computers via a network.

One computer may serve as the pairing client 3A or the share client 3B for a plurality of personal cloud servers 2. Further, it is possible for one computer to serve as the pairing client 3A for a certain personal cloud server 2, while serving as the share client 3B for another personal cloud server 2.

Now it is assumed a case where a plurality of users including user A, user B, and user C construct the present network system and share a folder. Further, a computer used by user A is defined as the personal cloud server 2, a computer used by user B is defined as the pairing client 3A, and a computer used by user C is defined as the share client 3B.

In this case, a folder which is shared by a plurality of users (shared folder) may be updated by users A and B. More specifically, user A can, for example, store, update, or delete a file in the shared folder by a direct operation from the computer of user A which is defined as the personal cloud server 2. Further, user B can, for example, upload, update, or delete a file in the shared folder by issuing an access request to the management server 1 from the computer of user B which is defined as the pairing client 3A.

As described above, the network system manages the relationship between the personal cloud server 2, and the pairing client 3A and the share client 3B. Thus, if an update of a shared folder which may be updated as described above occurs, the management server 1 is made to give notification of the update to computers having the right to access the folder in question. This point will be described in detail below.

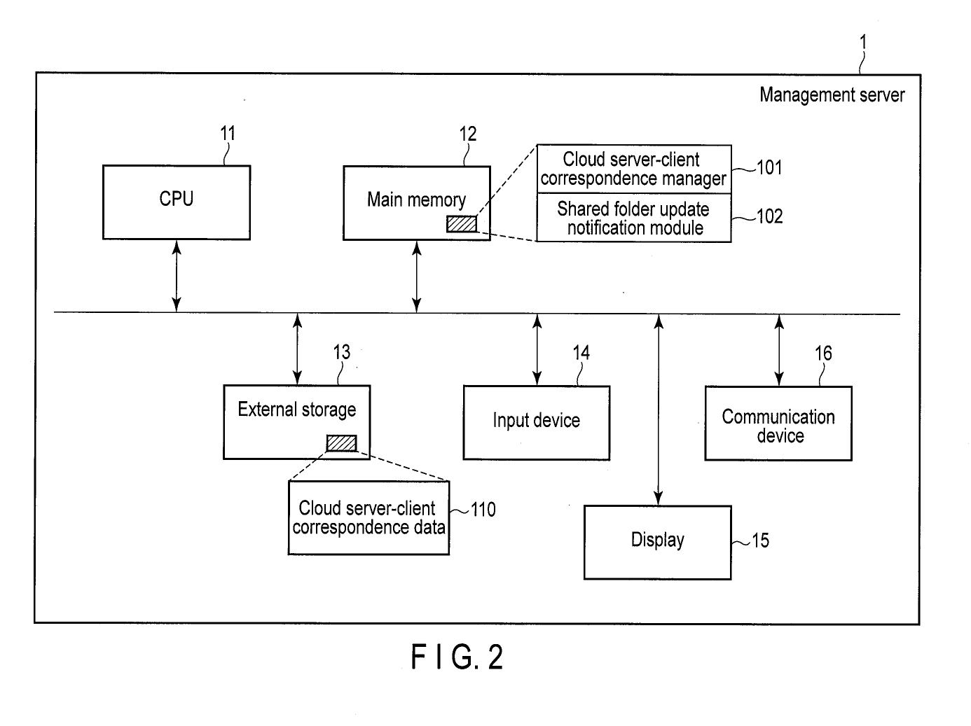

FIG. 2 is an exemplary illustration showing the structure of the management server 1 applied to the present network system.

As shown in FIG. 2, the management server 1 includes a CPU 11, main memory 12, external storage 13, an input device 14, a display 15, and a communication device 16.

The management server 1 may operate variously as the CPU 11 loads various programs into the main memory 12 from the external storage 13 and executes the same. The various programs include an operating system (OS) which is the basic software, and a cloud server-client correspondence manager 101, a shared folder update notification module 102, etc, operating under control of the OS. The cloud server-client correspondence manager 101 and the shared folder update notification module 102 will be described later. Further, various programs include a mailer (electronic mail software) for transmitting and receiving e-mails. The mailer also operates under control of the OS. Notification that a folder has been updated may be executed by transmission of an e-mail by the mailer, for example.

The input device 14 is a device which takes on the input side of a user interface provided by the management server 1, for example, a keyboard and a pointing device. The display 15 is a device which takes on the output side of the user interface provided by the management server 1, for example, a liquid crystal display (LCD). The communication device 16 is a device which executes communication via network A, such as the Internet.

As describe above, in the present network system, the personal cloud server 2 assigns the access rights to other computers (pairing client 3A or share client 3B) in units of folders created on the storage medium managed by the personal cloud server 2. Further, the management server 1 manages the cloud server-client correspondence data 110 in which each of the folders on the personal cloud server 2 is associated with the pairing client 3A or the share client 3B having the right to access each of those folders. The cloud server-client correspondence manager 101 is a program which serves to manage the cloud server-client correspondence data 110. The cloud server-client correspondence data 110 is stored in the external storage 13, such as a hard disk drive (HDD). The cloud server-client correspondence data 110 includes mail addresses of the personal cloud server 2, the pairing client 3A, and the share client 3B. The mail addresses may be managed separately from the cloud server-client correspondence data 110.

Meanwhile, the shared folder update notification module 102 is a program which notifies, when a folder on the personal cloud server 2 is updated, the pairing client 3A and the share client 3B having the right to access the folder in question that the folder has been updated, based on the cloud server-client correspondence data 110.

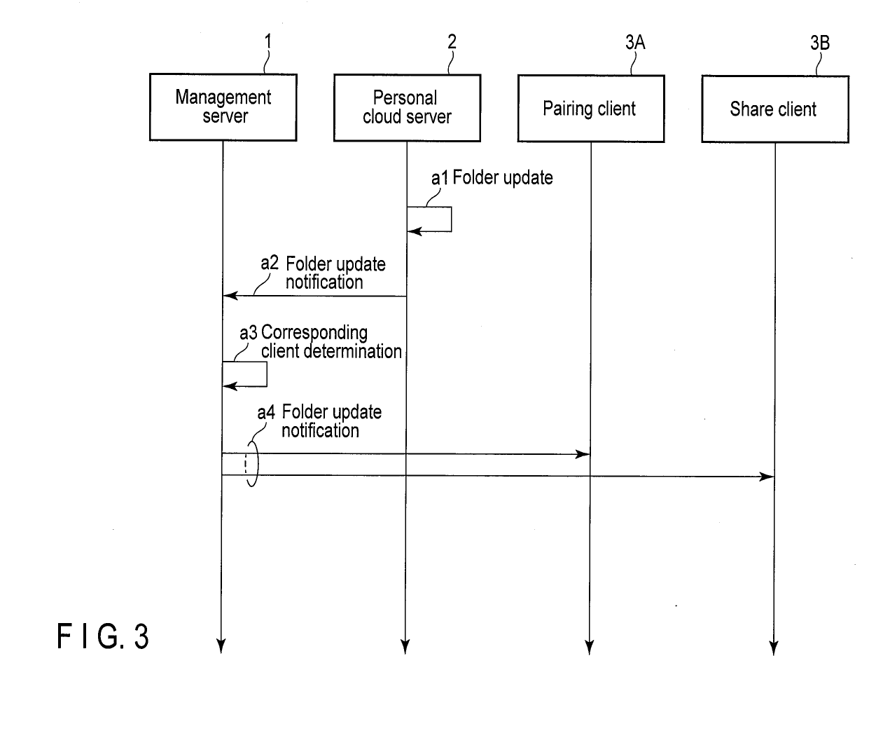

Firstly, with reference to FIG. 3, the overall flow of an operation of the present network system when a folder is directly updated on the personal cloud server 2 will be explained.

When a folder on the personal cloud server 2 is directly updated on the personal cloud server 2 (“a1” in FIG. 3), the personal cloud server 2 notifies the management server 1 of the update of that folder (“a2” in FIG. 3). When this notification is received by the management server 1, the shared folder update notification module 102 of the management server 1 determines the pairing client 3A and the share client 3B having the right to access that folder based on the cloud server-client correspondence data 110 (“a3” in FIG. 3). The shared folder update notification module 102 notifies the determined pairing client 3A and share client 3B that the folder has been updated (“a4” in FIG. 3).

As described above, notification from the management server 1 can be executed by transmission of an e-mail by the mailer. For example, when a user defines the computer used by himself/herself as the personal cloud server 2 and assigns the right to access a certain folder to a plurality of other users, the plurality of other users may include users who do not know each other. In view of such a situation, it is undesirable for the mail address of each user to be viewable through the e-mails giving notification of the update of folders even by users who have the right to access the same folder. Hence, the shared folder update notification module 102 of the management server 1 specifies the mail addresses of the destination users by a blind carbon copy (BCC), and broadcasts to the computers having the right to access the updated folder. In this way, it is possible to give notification of the folder update by use of a single mail and also hide the mail addresses of the destination users.

By the notification from the management server 1, each of the users of the pairing client 3A and the share client 3B can recognize that a folder on the personal cloud server 2 has been updated.

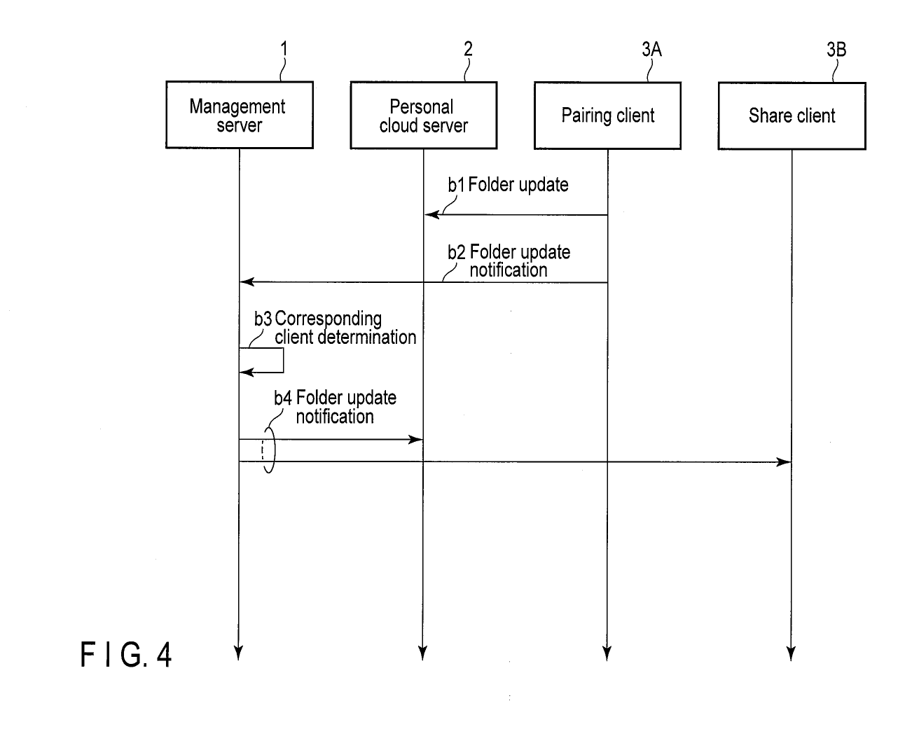

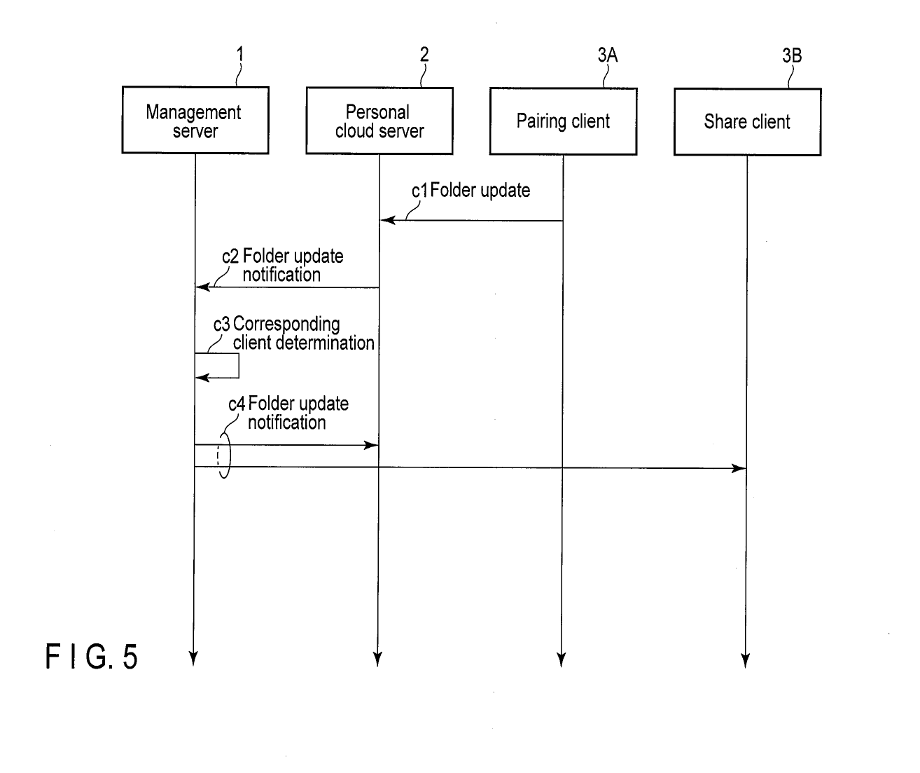

Next, with reference to FIG. 4 and FIG. 5, description will be given for the overall flow of the operation of the present network system when a folder on the personal cloud server 2 is updated by, for example, uploading, updating, or deleting a file by the pairing client 3A (having the update permitted access right).

In this case, there are two patterns of update notification. The first pattern (pattern 1) is that the pairing client 3A (which updates a folder) notifies the management server 1 of the update of the folder, and the second pattern (pattern 2) is that the personal cloud server 2 (whose folder is updated) notifies the management server 1 of the update.

Firstly, with reference to FIG. 4, the flow of operation of pattern 1 will be described.

When the pairing client 3A updates a folder on the personal cloud server 2 (“b1” in FIG. 4), the pairing client 3A gives notification to the management server 1 of the update of that folder (“b2” in FIG. 4). When this notification is received by the management server 1, the shared folder update notification module 102 of the management server 1 determines the pairing client 3A and the share client 3B having the right to access the folder, based on the cloud server-client correspondence data 110 (“b3” in FIG. 4). In FIG. 4, only one pairing client 3A is shown. However, a plurality of pairing clients 3A (including a pairing client 3A other than the pairing client 3A which updated the file) may exist. Further, a plurality of share clients 3B may exist.

The shared folder update notification module 102 gives notification of the update of the folder to the determined pairing client 3A and share client 3B, and to the personal cloud server 2 which manages the updated folder (“b4” in FIG. 4).

By the notification from the management server 1, each of the users of the personal cloud server 2, the pairing client 3A, and the share client 3B can recognize that a folder on the personal cloud server 2 has been updated.

In FIG. 4, notification to the pairing client 3A which updated the folder from the management server 1 is omitted. However, the shared folder update notification module 102 may be configured to uniformly give notification of the update of a folder (including the notification to the pairing client 3A which updated the folder) based on the cloud server-client correspondence data 110 without paying attention to which pairing client 3A updated the folder. Further, if the personal cloud server 2 separately has the function of informing a user of the update of a folder, for example, notification to the personal cloud server 2 from the management server 1 may be omitted.

As described above, if a folder on the personal cloud server 2 is updated, the update of the folder is notified by the management server 1. However, as aforementioned, a folder on the personal cloud server 2 may be updated by a direct operation from the personal cloud server 2. Alternatively, the folder may be updated by an access request issued by the pairing client 3A. Therefore, notification from the management server 1 may be the one which can distinguish (at the receiving end) which type of update from the above was made.

Next, with reference to FIG. 5, the flow of operation of pattern 2 will be described.

When a folder on the personal cloud server 2 is updated by the pairing client 3A (“c1” in FIG. 5), the personal cloud server 2 gives notification of the update of the folder to the management server 1 (“c2” in FIG. 5). When this notification is received by the management server 1, the shared folder update notification module 102 of the management server 1 determines the pairing client 3A and the share client 3B having the right to access the folder, based on the cloud server-client correspondence data 110 (“c3” in FIG. 5). As in FIG. 4, FIG. 5 shows only one pairing client 3A. However, a plurality of pairing clients 3A (including a pairing client 3A other than the pairing client 3A which updated the file) may exist. Further, a plurality of share clients 3B may exist.

The shared folder update notification module 102 gives notification of the update of the folder to the determined pairing client 3A and share client 3B, and to the personal cloud server 2 which manages the updated folder (“c4” in FIG. 5).

By the notification from the management server 1, each of the users of the personal cloud server 2, the pairing client 3A, and the share client 3B can recognize that a folder on the personal cloud server 2 has been updated.

As in FIG. 4, in FIG. 5, notification to the pairing client 3A which updated the folder from the management server 1 is omitted. However, the shared folder update notification module 102 may be configured to uniformly give notification of the update of a folder (including the notification to the pairing client 3A which updated the folder) based on the cloud server-client correspondence data 110 without paying attention to which pairing client 3A updated the folder. Further, if the personal cloud server 2 separately includes the function of informing a user of the update of a folder, for example, notification to the personal cloud server 2 from the management server 1 may be omitted.

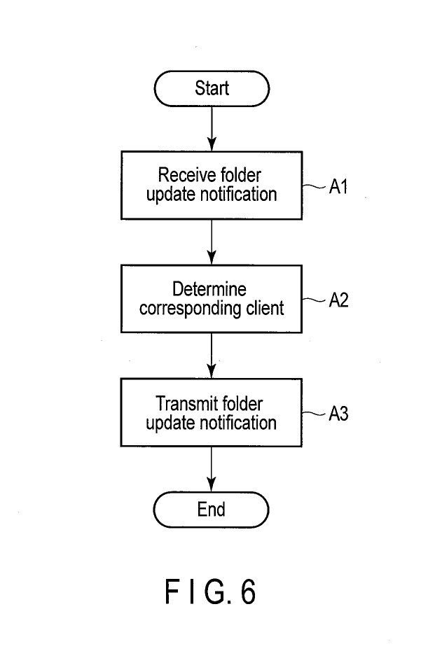

FIG. 6 is an exemplary flowchart showing the flow of folder update notification processing executed by the management server 1 applied to the present network system.

When the management server 1 receives update notification of a folder from the personal cloud server 2 or the pairing client 3A (block A1), the management server 1 determines the pairing client 3A and the share client 3B having the right to access that folder based on the cloud server-client correspondence data 110 (block A2).

The management server 1 transmits update notification of the folder to the determined pairing client 3A and share client 3B, and to the personal cloud server 2 which manages the folder (block A3).

As described above, the present network system enables to give update notification of shared information by the function of the management server 1 in a unified way.

An example given above is that the personal cloud server 2 assigns the access rights to the pairing client 3A or the share client 3B in units of folders on a storage medium managed by the personal cloud server 2, and the management server 1 gives notification of an update of a folder to the pairing client 3A or the share client 3B having the right to access the folder in question. In addition to the above, it is possible to structure the personal cloud server 2 to assign the access rights in units of files, not limited to folders. In accordance with this structure, it is possible to make the management server 1 notify the pairing client 3A or the share client 3B of the update of files, not limited to folders.

Since the operation control processing of each embodiment can be realized by software (a program), it is possible to easily realize an advantage similar to that of each embodiment by installing the software on an ordinary computer by way of a computer-readable storage medium containing the software, and executing the software (program).

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A network system comprising:
a first computer configured to set access rights to a storage medium managed by the first computer in units of folders or files;
a second computer having either (1) an access right of being permitted to update a first folder or a first file on the storage medium via a network, or (2) an access right of being prohibited from updating the first folder or the first file; and
a third computer configured to manage a relationship between the first computer and the second computer, and to serve as an intermediary between the first computer and the second computer via the network,
wherein the third computer comprises a first notification module configured to notify the second computer of an update of the first folder or the first file, when the first folder or the first file is updated.

2. The system of claim 1, wherein the first computer comprises a second notification module configured to notify the third computer of an update of the first folder or the first file, when the first folder or the first file is updated.

3. The system of claim 1, wherein the second computer comprises a third notification module configured to notify the third computer that the first folder or the first file has been updated, when the second computer accesses and updates the first folder or the first file.

4. The system of claim 1, wherein:
the third computer comprises an information manager configured to obtain first information indicating a setting status of the access rights to the storage medium in units of folders or files from the first computer, and to manage the obtained first information; and
the first notification module of the third computer is configured to specify the second computer as a computer to which the update of the first folder or the first file is to be notified, based on the first information managed by the information manager.

5. The system of claim 1, wherein the first notification module of the third computer is configured to notify of the update of the first folder or the first file by an e-mail.

6. The system of claim 5, wherein the first notification module of the third computer is configured to specify a destination of the e-mail by a blind carbon copy (BCC).

7. A management server comprising:
a specification module configured to specify a second computer as having a right to access, via a network, a first folder or a first file on a storage medium managed by a first computer, when the first folder or the first file is updated; and
a notification module configured to notify the second computer specified by the specification module that the first folder or the first file has been updated via the network.

8. The server of claim 7, further comprising a first receiver configured to receive notification of the update of the first folder or the first file from the first computer.

9. The server of claim 7, further comprising a second receiver configured to receive notification of the update of the first folder or the first file from the second computer.

10. The server of claim 7, further comprising an information manager configured to obtain first information indicating a setting status of the access rights to the storage medium in units of folders or files from the first computer, and to manage the obtained first information,
wherein the specification module is configured to specify the second computer as a computer to which the update of the first folder or the first file is to be notified, based on the first information managed by the information manager.

11. The server of claim 7, wherein the notification module is configured to notify of the update of the first folder or the first file by an e-mail.

12. The server of claim 11, wherein the notification module is configured to specify a destination of the e-mail by a blind carbon copy (BCC).

13. An update notification method of a management server configured to manage a relationship between a first computer and a second computer, and to serve as an intermediary of connection between the first computer and the second computer via a network, the method comprising:
specifying the second computer as having a right to access, via the network, a first folder or a first file on a storage medium managed by the first computer, when the first folder or the first file is updated; and
notifying the second computer that the first folder or the first file has been updated via the network.

14. The method of claim 13, further comprising receiving notification of the update of the first folder or the first file from the first computer.

15. The method of claim 13, further comprising receiving notification of the update of the first folder or the first file from the second computer.

16. The method of claim 13, further comprising obtaining first information indicating a setting status of access rights to the storage medium in units of folders or files from the first computer, and managing the obtained first information,
wherein the specifying the second computer comprises specifying the second computer as a computer to which the update of the first folder or the first file is to be notified, based on the first information.

17. The method of claim 13, wherein the notifying comprises notifying of the update of the first folder or the first file by an e-mail.

18. The method of claim 17, wherein the notifying comprises specifying a destination of the e-mail by a blind carbon copy (BCC).
